(19) United States
(12) Patent Application Publication
(10) Pub. No.: US 2014/0176295 A1
(43) Pub. Date: Jun. 26, 2014

(54) SHOCK PROOF SYSTEM FOR PORTABLE ELECTRONIC DEVICES

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: JIAN-HUNG HUNG, New Taipei (TW); XIN-SHU WANG, Wuhan (CN); MIN YANG, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 13/974,170

(22) Filed: Aug. 23, 2013

(30) Foreign Application Priority Data
Dec. 22, 2012 (CN) 2012105617691

(51) Int. Cl. H04M 1/03

(52) U.S. Cl. CPC H04M 1/03
USPC 340/3.1

(57) ABSTRACT

A shock proof system includes a detecting module, a receiving module, a sensing module, and a protecting module. The detecting module is used to output a protecting signal. The receiving module is fixed on a device. The receiving module is connected to the detecting module through a signal line to receive the protecting signal continuously. When the receiving module does not receive the protecting signal, the receiving module outputs a first signal. The sensing module is fixed on the device to sense the acceleration of the device. When the acceleration of the device equals to an acceleration of gravity, the sensing module outputs a second signal. The protecting module is used to protect the device when the protecting module receives both of the first and second signals at the same time.

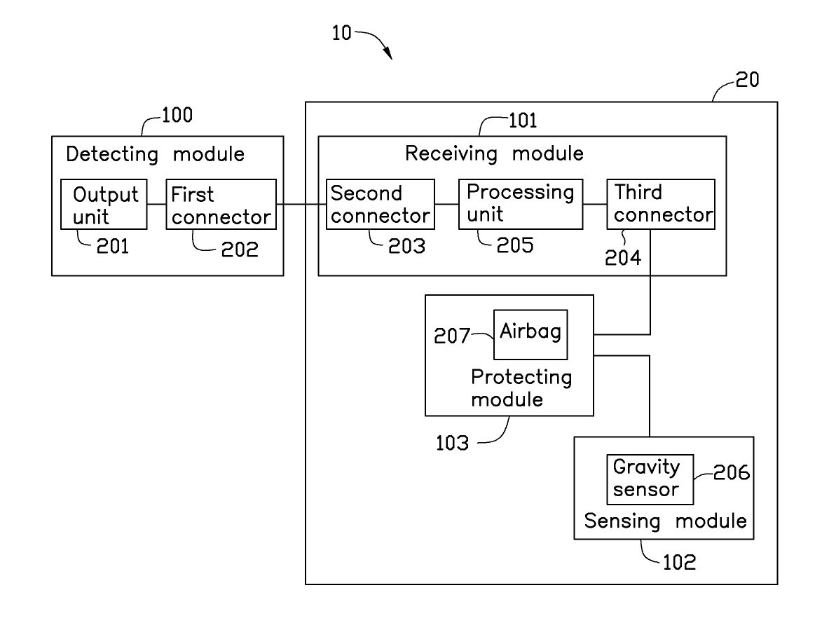

### BACKGROUND

1. Technical Field

The present disclosure relates to a shock proof system for portable electronic devices.

2. Description of Related Art

Portable electronic devices, such as mobile phones and personal digital assistants, are used more and more. There is a risk that the portable electronic devices could be dropped when in use, which would cause damage.

Therefore, there is room for improvement in the art.

### BRIEF DESCRIPTION OF THE DRAWING

Many aspects of the present disclosure can be better understood with reference to the following drawing(s). The components in the drawing(s) are not necessarily drawn to scale, the emphasis instead being placed upon clearly illustrating the principles of the present disclosure. Moreover, in the drawing(s), like reference numerals designate corresponding parts throughout the several views.

The FIGURE is a block diagram of an embodiment of a shock proof system of the present disclosure.

### DETAILED DESCRIPTION

The FIGURE shows an embodiment of a shock proof system 10 of the present disclosure.

The shock proof system 10 includes a detecting module 100, a receiving module 101, a sensing module 102, and a protecting module 103.

In this embodiment, the detecting module 100 a device fixed on a desk with a suction cup. The detecting module 100 includes an output unit 201 and a first connector 202. The output unit 201 is a device used to output a protecting signal continuously through the first connector 202.

The receiving module 101 is a device fixed on the surface of a device 20, such as a mobile phone or a personal digital assistant. The receiving module 101 includes a second connector 203, a third connector 204, and a processing unit 205. The second connector 204 is connected to the first connected 202 through a signal line. The processing unit 205 receives the protecting signal continuously through the second connector 203. Once the device 20 is disconnected from the detecting module 100, the processing unit 205 cannot receive the protecting signal, and the processing unit 205 outputs a first signal through the third connector 204.

The sensing module 102 is fixed on the surface of the device 20. The sensing module 102 includes a gravity sensor 206. The gravity sensor 206 is used to sense whether the device 20 has an acceleration of gravity. If the device 20 has an acceleration equal to the acceleration of gravity, the sensing module 102 determines that the device 20 is falling, and outputs a second signal to the protecting module 103.

The protecting module 103 is connected to the receiving module 101 and the sensing module 102, to receive the first and second signals. When the protecting module 103 receives both of the first and second signals at the same time, the protecting module 103 determines that the device 20 is falling and is disconnected from the detecting module 100. The protecting module 103 starts to protect the device 20. In this embodiment, the protecting module 103 includes an airbag 207. When the protecting module 103 receives both of the first and second signals, the protecting module 103 opens the airbag 207 to protect the device 20.

When the protecting module 103 receives the first signal but does not receive the second signal, the protecting module 103 determines the device 20 is disconnected from the detecting module 100 and is not falling. The protecting module 103 will not protect the device 20. When the protecting module 103 receives the second signal but does not receive the first signal, the protecting module 103 determines the device 20 to be protected is falling but the device 20 is not disconnected from the detecting module 100. The signal line keeps the connection between the device 20 and the detecting module 100. The protecting module 103 will not protect the device 20.

While the disclosure has been described by way of example and in terms of preferred embodiment, it is to be understood that the disclosure is not limited thereto. To the contrary, it is intended to cover various modifications and similar arrangements as would be apparent to those skilled in the art. Therefore, the range of the appended claims should be accorded the broadest interpretation so as to encompass all such modifications and similar arrangements.

What is claimed is:

1. A shock proof system for a device, comprising:
a detecting module outputting a protecting signal continuously;
a receiving module fixed on the device, wherein the receiving module is connected to the detecting module through a signal line to receive the protecting signal continuously, and when the receiving module does not receive the protecting signal, the receiving module outputs a first signal;
a sensing module fixed on the device to sense an acceleration of the device, wherein when the acceleration of the device equals an acceleration of gravity, the sensing module outputs a second signal;
a protecting module to protect the device when the protecting module receives both of the first and second signals at the same time.

2. The shock proof system of claim 1, wherein the detecting module comprises an output unit and a first connector, the output unit outputs the protecting signal continuously through the first connector.

3. The shock proof system of claim 2, wherein the receiving module comprises a processing unit and a second connector, the second connector is connected to the first connector through the signal line, the second connector is connected to the processing unit to transmit the protecting signal to the processing unit.

4. The shock proof system of claim 3, wherein the receiving module further comprises a third connector, the processing unit outputs the first signal through the third connector, when the processing unit does not receive the protecting signal.

5. The shock proof system of claim 1, wherein the sensing module comprises a gravity sensor to sense the acceleration of the device.

6. The shock proof system of claim 1, wherein the protecting module comprises an airbag, when the protecting module receives both of the first and second signals at the same time, the airbag is opened to protect the device.
